(19) United States
(12) Patent Application Publication
(10) Pub. No.: US 2013/0039844 A1
(43) Pub. Date: Feb. 14, 2013

(54) PROCESS FOR MAKING TITANIUM COMPOUNDS

(71) Applicant: Jeffrey Scott Thompson, West Chester, PA (US)

(72) Inventor: Jeffrey Scott Thompson, West Chester, PA (US)

(73) Assignee: E I Du Pont De Nemours and Company, Wilmington, DE (US)

(21) Appl. No.: 13/642,578

(22) PCT Filed: May 20, 2011
(86) PCT No.: PCT/US11/37344

§ 371 Date: Oct. 22, 2012

Related U.S. Application Data
(60) Provisional application No. 61/347,249, filed on May 21, 2010.

(51) Int. Cl. C01D 15/02

(52) U.S. Cl. 423/598

(57) ABSTRACT

Disclosed is a process for the preparation of Li₄Ti₅O₁₂ by a novel, low-cost route from titanium tetrachloride. Material prepared by this new process has properties (such as purity, particle size and tap density) that are useful for good performance in a lithium ion battery.

This application claims priority under 35 U.S.C. §119(e) from, and claims the benefit of, U.S. Provisional Application No. 61/347,249, filed May 21, 2010, which is by this reference incorporated in its entirety as a part hereof for all purposes.

### TECHNICAL FIELD

The subject matter of this disclosure relates to a process for the preparation of Li₄Ti₅O₁₂ by a novel, low-cost route from titanium tetrachloride. Material prepared by this new process has properties (such as purity, particle size and tap density) that are useful for good performance in a lithium ion battery.

### BACKGROUND

Lithium ion batteries (LIB) have many current and potential uses. Potential applications include grid-scale energy storage and transportation (e.g. hybrid electric vehicles, electric vehicles and electric trains).

The need for grid-scale energy storage capacity is evident in the evolution of energy generation in the U.S. Electric power in the U.S. is generated from coal and natural gas. Yet carbon dioxide from this electricity generation accounts for >40% of the country's carbon dioxide output. Increased power generation from renewable energy sources such as solar and wind is needed to mitigate the effects of increasing atmospheric concentration of carbon dioxide. However, the combination of intermittent renewable power generation and the inability of aging power grids to manage variations in electricity supply and demand are limitations of the power grid in its current state. Grid-scale energy storage is necessary to enhance the efficiency and reliability of the electric power distribution.

There has been a number of battery systems developed for energy storage needs. LIBs are well-suited for this application in terms of performance (round-trip efficiency, life time, ease of use) when compared with the other alternatives such as molten salt batteries and advanced lead-acid batteries. The major factors in technology choice for grid-scale energy storage are cost, lifetime, and safety. Li₄Ti₅O₁₂ (LTO) anodes have been shown to have a long life time. The batteries are also safe compared with other batteries owing to the materials of construction and the absence of the electrochemical decomposition of the electrolyte at the electrode surface.

LTO has been prepared previously by several methods. The solid-state reaction of TiO₂ with lithium carbonate has been demonstrated but yields small particles with low tap density.

Another process known in the art is based on the use of TiCl₄ in an HCl solution containing LiCl. The solution is spray dried to yield a solid that contains rutile and a Li salt; there is no reaction between the two materials in the mixture at this point. The mixture is calcined at about 800-1000° C. to generate LTO. This material then goes through repeated grinding and additional calcining steps to achieve nano-sized particles.

Similar processes have been described to prepare LTO that involve addition of TiCl₄ to an aqueous solution followed by neutralization of by-product HCl with ammonia. Titanium dioxide as anatase is generated in this step. This titanium dioxide is mixed with LiOH and is then spray dried to yield particles of desired sized. Calcination under nitrogen and then under ambient atmosphere yields LTO.

Because the cost for materials is the largest cost component in LIB manufacture, the use of low-cost materials will offer a significant commercial advantage. A need thus remains for a simple, streamlined preparation of LTO having useful properties (such as purity, particle size and shape) for LIB applications by a process that uses inexpensive reagents.

### SUMMARY

The various processes described herein address the needs in the art by providing processes for preparing Li₄Ti₅O₁₂. In one embodiment hereof, there is provided a process for preparing Li₄Ti₅O₁₂ by (a) hydrolyzing TiCl₄ in a reaction mixture to provide TiOCl₂, (b) heating TiOCl₂ to provide a titanium dioxide, and (c) contacting the titanium dioxide with a lithium salt to prepare Li₄Ti₅O₁₂.

The processes disclosed herein offer several advantages among which are the ability to recover LTO directly from a solution in the absence of a step of having to remove by-products such as sulfate salts, and/or the absence of a step of recovering the product by an external method such as spray drying.

In another embodiment hereof, there is provided a process for preparing titanium dioxide by (a) hydrolyzing TiCl₄ in a reaction mixture to provide TiOCl₂, and (b) heating TiOCl₂ to provide a titanium dioxide.

### BRIEF DESCRIPTION OF THE DRAWINGS

FIG. 1 is a scanning electron micrograph of particles of hydrated titanium dioxide produced in Example 6.

FIG. 2 is a scanning electron micrograph of particles of lithium titanate produced in Example 7.

### DETAILED DESCRIPTION

Processes to prepare Li₄Ti₅O₁₂ have been discovered and are disclosed herein. In one embodiment of these processes, a hydrolysis reaction generates a titanium precursor that can be combined with a lithium salt, and a further hydrolysis reaction is conducted in the presence of the lithium salt to enable co-precipitation of both lithium and titanium. The precipitated product can then further be calcined, if desired.

One embodiment of the processes hereof involves the hydrolysis of TiCl₄ to TiOCl₂ in water, followed by thermal hydrolysis to titanium dioxide, typically in hydrated form and rutile phase, as shown in Equation 1.

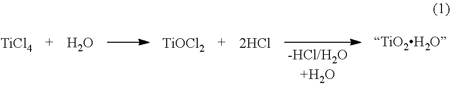

The initial step in Equation 1 is the hydrolysis of TiCl₄ to TiOCl₂ with formation of by-product HCl. A clear or slightly hazy colorless solution is typically generated in this step. These particles do not agglomerate on standing or on reaction with a lithium salt, and reaction with the lithium salt generates LTO, as shown in Equation 2.

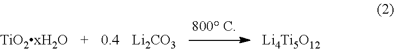

In another embodiment of the processes hereof, Li₄Ti₅O₁₂ is prepared by (a) hydrolyzing TiCl₄ in a reaction mixture to provide TiOCl₂, (b) heating TiOCl₂ to provide a titanium dioxide, and (c) contacting titanium dioxide with lithium hydroxide or lithium carbonate to prepare Li₄Ti₅O₁₂.

In the process of the above step (a), TiCl₄ is added to water with agitation, typically at a rate in the range of about 40 mL/hour to about 60 mL/hour, or a range of about 45 mL/hour to about 55 mL/hour. The TiCl₄ is preferably handled under an inert, dry atmosphere until addition is performed. The water used in this step can be maintained at a temperature of about −20° C. or more, or about −15° C. or more, or about −10° C. or more, or about −5° C. or more, and yet at a temperature of about 20° C. or less, or about 15° C. or less, or about 10° C. or less, or about 5° C. or less; or at a temperature in the range of about −20° C. to about 20° C., or about −5° C. to about 5° C. The resulting TiOCl₂ can be isolated by any conventional means; or can also be, and is more typically, used as the water solution in further steps of the processes. In one embodiment, this process in this step is characterized by the absence of a step of adding to the reaction mixture other or additional components or reagents, such as a surfactant or an acid such as HCl.

In the process of the above step (b), the TiOCl₂ is heated to provide TiO₂. In this step, the TiOCl₂ can be heated to a temperature of about 50° C. or more, or about 52° C. or more, or about 56° C. or more, or about 60° C. or more, and yet to a temperature of about 120° C. or less, or about 100° C. or less, or about 90° C. or less, or about 80° C. or less; or to a temperature in the range of about 50° C. to about 120° C., or to a temperature in the range of about 60° C. to about 80° C.

In another embodiment, step (b) comprises heating TiOCl₂ in a mixture with water, and the mixture is provided with vigorous stirring or turbulent mixing. The titanium dioxide precipitates during the reaction and HCl is generated, forming a reaction mixture comprising water, TiO₂, and HCl. This reaction mixture can contain titanium in an amount of at least about 0.8 M, or at least about 0.9 M, or at least about 1.0 M, or at least about 1.1 M, and yet in an amount of no more than about 1.6 M, or no more than about 1.4 M, or no more than about 1.3 M, or no more than 1.2 M; or can contain titanium in an amount in the range of about 0.8 M to about 1.6 M of Ti, or about 0.9 M to about 1.2 M. In one embodiment, this process in this step is also characterized by the absence of a step of adding to the reaction mixture other or additional components or reagents, such as a surfactant or an acid such as HCl.

At higher concentrations of titanium, as set forth above, higher temperatures can be used. For example, when titanium concentration is in the range of at least about 1.0 M and yet no more than about 1.6 M, the temperature of the thermal hydrolysis can be in the range of about 60° C. or more and yet about 120° C. or less.

In another embodiment, the reaction mixture is distilled to remove HCl, and the reaction mixture can for such purpose be heated to a temperature in the range of about 100° C. to about 120° C. as measured at the distillation head. The particles of TiO₂ that are formed during the precipitation can continue to grow or further nucleate during the distillation step.

In another embodiment, the process further includes a step of recovering TiO₂ from the reaction mixture of step (b), which contains water, TiO₂ and HCl, by (i) precipitating the titanium dioxide from the mixture at a temperature in the range of about 60° C. to about 70° C., and (ii) heating the mixture at a temperature in the range of about 75° C. to about 85° C. The particles of TiO₂ that are formed during the precipitation can continue to grow or further nucleate during the second heating step.

In another embodiment, the process further includes a step of filtering and washing the reaction mixture of step (b), which contains water, TiO₂ and HCl. The reaction mixture can be washed with water, and is filtered and washed in order to remove HCl and isolate the precipitated TiO₂.

The TiO₂ that is formed in step (b) is typically in rutile phase, or is a mixture of substantially rutile phase with other phases. It can optionally be isolated and/or recovered, typically as a dried solid, using conventional methods such as filtration or centrifugation. Typically the TiO₂ is isolated in a hydrated form. The titanium dioxide referred to herein can thus be crystalline or amorphous TiO₂, or hydrated crystalline or hydrated amorphous TiO₂, or a mixture thereof.

Processes to prepare titanium dioxide can be performed by using steps (a) and (b) in the same manner as set forth above.

In the process of step (c), titanium dioxide is contacted with a lithium salt, preferably a soluble lithium salt, to prepare Li₄Ti₅O₁₂. Examples of lithium salts suitable for use herein for such purpose include lithium hydroxide, lithium carbonate, lithium sulfate, lithium phospate and lithium carboxylates such as lithium formate, lithium acetate, lithium citrate or lithium benzoate.

In one embodiment, titanium dioxide is contacted with a lithium salt as a mixture in water with agitation. In another embodiment, titanium dioxide is mixed with the lithium salt in relative amounts such that there is a molar ratio of Li/Ti of about 0.6 to about 1.0, or about 0.7 to about 0.9. In another embodiment, titanium dioxide is contacted with a lithium salt at a temperature in the range of about 10° C. to about 115° C., or about 90° C. to about 110° C., typically with agitation. In another embodiment, contact between titanium dioxide and a lithium salt can be maintained until the mixture has substantially dried and is in the form of a powder, which can involve a period of about 1 to about 2 hours.

The LTO, prepared as set forth above, can then be further heated. The additional heating can be performed while the LTO still resides in an aqueous mixture, or after the LTO has been obtained in the form of a powder. In either case, heating can be conducted at a temperature of at least about 600° C., or at least about 700° C., or at least about 750° C., and yet no more than about 1000° C., or no more than about 900° C., or nor more than about 800° C.; or a temperature in the range of about 600° C. to about 1000° C. In one embodiment, the mixture is slowly heated until it reaches about 600° C. Heating can be conducted for a time period of at least about 5 hours, at least about 8 hours, or at least about 11 hours, and yet no more than about 20 hours, or no more than about 17 hours, or no more than about 14 hours; or a time period in the range of about 8 to about 20 hours. Heating can be conducted with conventional equipment such as an oven or a heating mantle.

The processes described herein can be used to prepare particles of LTO wherein a high proportion of them typically have a relatively uniform size and shape. For example, the particles are typically spherical in shape, typically have an average diameter of about 1 to about 20 microns, and are typically characterized by a narrow particle size distribution. Size for such purpose can be measured directly from a scanning electron micrograph, or by light scattering techniques. From the spherical particles, particle having other, irregular shapes (such as shapes involving asperities, edges, points and flat areas) can if desired be obtained by fragmentation, which may involve methods such as grinding.

The processes hereof further provide a step of fabricating from the LTO obtained as set forth above an electrode for use in an electrochemical cell such as a battery. An electrode is prepared by forming a paste from the LTO and a binder material such as a fluorinated (co)polymer (e.g. polyvinylfluoride) by dissolving or dispersing the solids in a water or an organic solvent. The paste is coated onto a metal foil, preferably an aluminum or copper foil, which is used as a current collector. The paste is dried, preferably with heat, so that the solid mass is bonded to the metal foil.

The processes hereof further provide a step of fabricating from an electrode, prepared as set forth above, an electrochemical cell such as a battery. A metal foil, prepared as described above, is provided as the anode or cathode (usually the anode), and a second metal foil is provided by similar preparation from electrically-active materials such as platinum, palladium or a carbonaceous material including graphite as the other electrode. The two coated foils are layered in a stack but separated therein by a porous separator that serves to prevent short circuiting between the anode and the cathode. The porous separator typically consists of a single-ply or multi-ply sheet of a microporous polymer such as polyethylene, polypropylene, or a combination thereof. The pore size of the porous separator is sufficiently large to permit transport of ions, but small enough to prevent contact of the anode and cathode either directly or from particle penetration or dendrites which can from on the anode and cathode.

The stack is rolled into an elongated tube form and is assembled in a container with numerous other such stacks that are wired together for current flow. The container is filled with an electrolyte solution, such as a linear or cyclic carbonate, including ethyl methyl carbonate, dimethyl carbonate or diethylcarbonate. The container when sealed forms an electrochemical cell such as a battery.

The processes provided herein further provide a step of incorporating or installing an electrochemical cell, prepared as set forth above, into an electronically-powered device such as a computer, a telecommunication device, a power tool, or a motor vehicle.

### EXAMPLES

The operation and effects of certain embodiments of the inventions hereof may be more fully appreciated from a series of examples, as described below. The embodiments on which these examples are based are representative only, and the selection of those embodiments to illustrate the invention does not indicate that reactants, conditions, specifications, steps, techniques or protocols not described in the examples are not suitable for use herein, or that subject matter not described in the examples is excluded from the scope of the appended claims and equivalents thereof.

### Materials

Ion-chromatography grade water obtained from a Satorius Arium 611DI unit (Sartorius North America Inc., Edgewood, N.Y.) was used to prepare solutions and rinse glassware prior to use. Titanium tetrachloride (Aldrich ReagentPlus, 99.9%, #208566) was purchased from Sigma-Aldrich (Milwaukee, Wis. 53201). Lithium carbonate (Puratronic, 99.998%) and lithium hydroxide monohydrate (99.995%) were obtained from Alfa Aesar (Ward Hill, Mass. 01835).

### Preparation of Titanium Oxy Chloride (TiOCl₂) Solution

Titanium tetrachloride was handled in a Vacuum Atmosphere dry box under a nitrogen atmosphere to load a 60-mL polypropylene Luer lock syringe for preparation of titanium oxy chloride solutions. The capped, loaded syringe was removed from the dry box. A flexible Luer lock tubing assembly (Hamilton 90615) was used to transfer the titanium tetrachloride into the reaction vessel with KD Scientific syringe pump. A two-neck 1000 mL round-bottom flask with a Teflon-coated stir bar was loaded with 400 mL water. The reaction flask was cooled with a water-ice bath. The titanium tetrachloride was added by syringe pump to the cooled water solution at a 50 mL/hour rate. The titanium tetrachloride was dropped into vortex created by the rotating stir bar, but above water level to avoid clogging of tip. A clear, colorless solution with 7.20 wt percent titanium by ICP-AES was produced. Solution was stored at room temperature in a glass bottle until needed.

### Example 1

### Preparation of Hydrated Titanium dioxide

Titanium oxy chloride (TiOCl₂) solution prepared as described above (100 mL) was added to a 500-mL three-neck mL round-bottom flask. The flask was placed in the center of a 1000-mL heating mantel; the flask was buried in sand. An overhead stirrer with Teflon paddle blade and a distillation head and condenser were added. A 250 mL round-bottom flask was used as a condensate receiver. A temperature probe in contact with the solution was inserted into the third neck of the flask. The solution was heated at 109° C. until a white slurry formed. The exposed flask and condenser heat were wrapped in aluminum foil to allow the temperature at the distillation head to reach 109° C. at which point the HCl-water azeotrope was distilled. Approximately 50 mL of solution was collected. The solution in the reaction flask was a heterogeneous, milky solution of low viscosity. Filtration of the solution removed a small amount of solids. Dilution of the filtrate with water yielded a thick white precipitate, which was collected by filtration, washed, and air-dried. Hydrated titanium dioxide (23.16 g) was obtained. XRD analysis shows the formation of a rutile phase. ICP-AES analysis shows the solid to contain 52.10 wt percent titanium.

### Example 2

### Preparation of Lithium Titanate (Li₄Ti₅O₁₂)

Hydrated titanium dioxide described in Example 1 above (5.0 g.) was mixed with lithium carbonate (1.6080 g) and 10 mL of water for two hours. The slurry was dried at 100° C. for one hour. The dry powder was transferred to an alumina crucible and heated at 800° C. overnight. The sample was allowed to cool in the furnace to ambient temperature. A white powder (4.22 g) was obtained. XRD data confirm the formation of Li₄Ti₅O₁₂.

### Example 3

### Preparation of Lithium Titanate (Li₄Ti₅O₁₂)

Hydrated titanium dioxide prepared described in Example 1 above (10.0 g, 53.5 wt percent Ti by ICP-AES.) was mixed with lithium hydroxide (3.7508 g) and 10 mL of water. The slurry was dried at 100° C. for 1 hour. The dry powder was transferred to an alumina crucible and heated at 800° C. overnight. The sample was allowed to cool in the furnace to ambient temperature. A white powder (9.994 g) was obtained. XRD data confirm the formation of Li₄Ti₅O₁₂.

### Example 4

### Preparation of Hydrated Titanium Dioxide

Titanium oxychloride (TiOCl₂) solution prepared as described above (110 mL) was added to a 500-mL three-neck mL round-bottom flask. The solution was diluted with 110 mL of water. The flask was placed in the center of a 1000-mL heating mantel; the flask was buried in sand. An overhead stirrer with Teflon paddle blade and a distillation head and condenser were added. A 250 mL round-bottom flask was used as a condensate receiver. A temperature probe in contact with the solution was inserted into the third neck of the flask. The solution was heated at 109° C. until a white slurry formed. The reaction mixture was filtered. The collected solid was washed with water and air-dried. A fine white powder (20.88 g) was collected.

### Example 5

### Preparation of Lithium Titanate (Li₄Ti₅O₁₂)

Hydrated titanium dioxide prepared described in Example 4 above (5.0 g, 50.2 wt percent Ti by ICP-AES.) was mixed with lithium carbonate (1.6269 g) and 10 mL of water for two hours. The slurry was dried at 100° C. for 1 hour. The dry powder was transferred to an alumina crucible and heated at 800° C. overnight. The sample was allowed to cool in the furnace to ambient temperature. A white powder (4.2090 g) was obtained. XRD data confirm the formation of Li₄Ti₅O₁₂.

### Example 6

### Preparation of Hydrated Titanium Dioxide

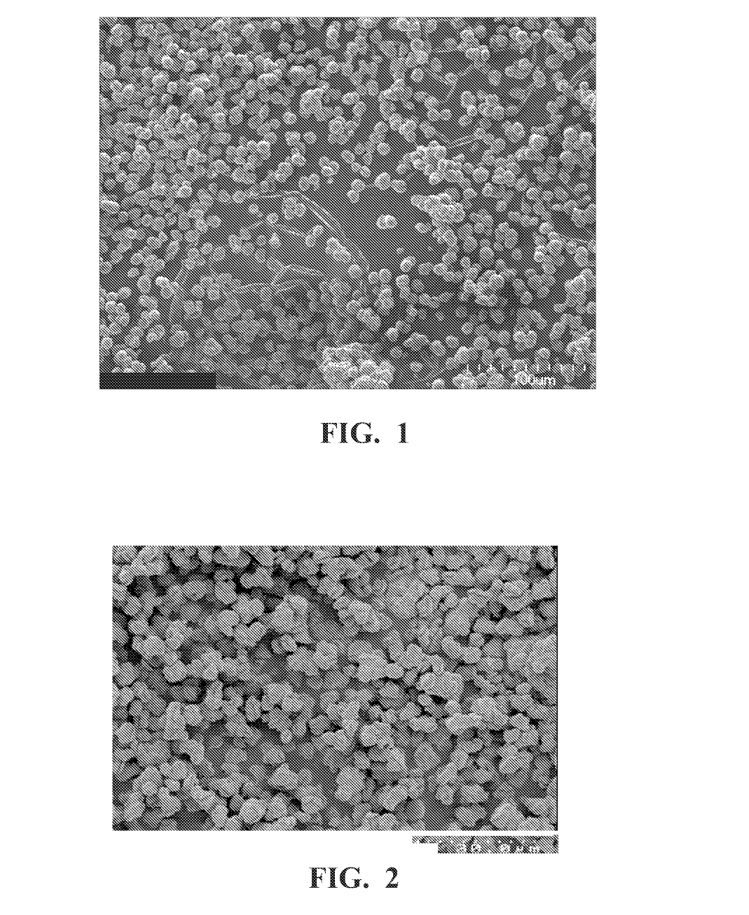

Titanium oxy chloride (TiOCl₂) solution prepared as described above (100 mL of 1.92 M TiOCl₂ solution) and 110 mL water were added to a 500 mL 3-neck Morton flask fitted with an overhead digital stirrer, thermo-probe temperature controller and a off-gas vent to a sodium bicarbonate scrubber. The TiOCl₂/water solution was heated to 65° C. for about 3 hours to allow particle nucleation. The single paddle impeller was rotated at 925 rpm. The temperature was then raised to 80° C. for two hours to grow the particles. A white slurry was generated. The solids were then collected by filtration, washed with water, and air dried. 11.72 g of a white, free-flowing powder with 53.6 wt percent titanium was collected. SEM photograph (shown in FIG. 1) shows particles of uniform size and shape

### Example 7

### Preparation of Lithium Titanate (Li₄Ti₅O₁₂)

Hydrated titanium dioxide prepared described in Example 6 above (5.0 g, 53.6 wt percent Ti by ICP-AES.) was mixed with lithium carbonate (1.766 g) and 15.8 mL of water for two hours by rotating the reaction flask at 100 rpm. The slurry was then dried at 100° C. for 2 hour. The dry powder was transferred to an alumina crucible and heated at 800° C. overnight. The sample was allowed to cool in the furnace to ambient temperature. A white powder (4.2090 g) was obtained. XRD data confirm the formation of Li₄Ti₅O₁₂. SEM photograph (shown in FIG. 2) shows particles of uniform size and shape

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

In this specification, unless explicitly stated otherwise or indicated to the contrary by the context of usage, amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value.

What is claimed is:

1. A process for preparing Li₄Ti₅O₁₂, comprising (a) hydrolyzing TiCl₄ in a reaction mixture to provide TiOCl₂, (b) heating TiOCl₂ to provide a titanium dioxide, and (c) contacting titanium dioxide with a lithium salt to prepare Li₄Ti₅O₁₂.

2. A process according to claim 1 wherein step (a) is performed in water.

3. A process according to claim 1 wherein step (a) comprises contacting TiCl₄ with water to hydrolyze it.

4. A process according to claim 1 wherein step (a) is performed at a temperature in the range of about −20° C. to about 20° C.

5. A process according to claim 1 wherein step (a) is performed at a temperature in the range of about −5° C. to about 5° C.

6. A process according to claim 1 wherein in step (b) TiOCl₂ is heated to a temperature in the range of about 50° C. to about 120° C.

7. A process according to claim 1 wherein in step (b) TiOCl₂ is heated to a temperature in the range of about 60° C. to about 80° C.

8. A process according to claim 1 wherein step (b) comprises heating TiOCl₂ in a mixture with water to form titanium dioxide and HCl.

9. A process according to claim 8 wherein the mixture is provided with vigorous stirring or turbulent mixing.

10. A process according to claim 8 wherein step (b) further comprises (i) precipitating titanium oxide in a mixture with HCl, and (ii) distilling the mixture to remove HCl.

11. A process according to claim 10 wherein the mixture is distilled a temperature in the range of about 100° C. to about 120° C.

12. A process according to claim 8 wherein step (b) further comprises (i) precipitating the titanium dioxide from the mixture at a temperature of about 60° C. to about 70° C., and (ii) heating the mixture at a temperature of about 75° C. to about 85° C.

13. A process according to claim 8 wherein step (b) further comprises (i) precipitating the titanium dioxide from the mixture, and (ii) filtering and washing the mixture to remove HCl.

14. A process according to claim 1 wherein step (b) further comprises recovering titanium dioxide as a dried solid.

15. A process according to claim 1 wherein step (c) comprises contacting titanium dioxide with a lithium salt in a mixture in water.

16. A process according to claim 1 wherein step (c) comprises contacting titanium dioxide with a lithium salt in relative amounts such that there is a molar ratio of Li/Ti of about 0.6 to about 1.0.

17. A process according to claim 1 wherein step (c) comprises contacting titanium dioxide with a lithium salt in relative amounts such that there is a molar ratio of Li/Ti of about 0.7 to about 0.9.

18. A process according to claim 15 wherein the mixture of step (c) is heated at a temperature in the range of about 10° C. to about 115° C.

19. A process according to claim 18 which further comprises heating the mixture at a temperature in the range of about 600° C. to about 1000° C.

20. A process according to claim 19 wherein the mixture is heated at a temperature in the range of about 600° C. to about 1000° C. for a period of about 8 to about 20 hours.

21. A process according to claim 1 further comprising a step of fabricating from Li₄Ti₅O₁₂ an electrode for an electrochemical cell.

22. A process according to claim 21 further comprising a step of fabricating an electrochemical cell from the electrode.

23. A process according to claim 22 further comprising incorporating the electrochemical cell into an electronically-powered device.

24. A process for preparing titanium dioxide, comprising (a) hydrolyzing TiCl₄ in a reaction mixture to provide TiOCl₂, and (b) heating TiOCl₂ to provide a titanium dioxide.
